(19) United States
(12) Patent Application Publication
(10) Pub. No.: US 2016/0011835 A1
(43) Pub. Date: Jan. 14, 2016

(54) IMAGE PROCESSING SYSTEM, IMAGE PROCESSING APPARATUS, TERMINAL APPARATUS, IMAGE PROCESSING METHOD, AND NON-TRANSITORY COMPUTER READABLE MEDIUM

(71) Applicant: FUJI XEROX CO., LTD., Tokyo (JP)

(72) Inventor: Osamu IGARASHI, Kanagawa (JP)

(73) Assignee: FUJI XEROX CO., LTD., Tokyo (JP)

(21) Appl. No.: 14/680,165

(22) Filed: Apr. 7, 2015

(30) Foreign Application Priority Data
Jul. 10, 2014 (JP) 2014-142684

(51) Int. Cl. G06F 3/12

(52) U.S. Cl. CPC G06F 3/1292; G06F 3/1237

(57) ABSTRACT

An image processing apparatus includes a first communication unit that wireless-communicates with a terminal apparatus, a second communication unit that is different from the first communication unit and wireless-communicates with the terminal apparatus, a transmitting unit that receives from the terminal apparatus via the second communication unit a suspend instruction to suspend an operation to perform a print instruction that instructs a document to be printed, and suspends the operation to perform the print instruction, and transmits to the terminal apparatus via the first communication unit the print instruction with the operation thereof suspended, and a receiving unit that receives from the terminal apparatus via the second communication unit a resume instruction to resume the operation to perform the print instruction, and receives the print instruction from the terminal apparatus via the first communication unit.

### CROSS-REFERENCE TO RELATED APPLICATIONS

This application is based on and claims priority under 35 USC 119 from Japanese Patent Application No. 2014-142684 filed Jul. 10, 2014.

### BACKGROUND

### Technical Field

The present invention relates to an image processing system, an image processing apparatus, a terminal apparatus, an image processing method, and a non-transitory computer readable medium.

### SUMMARY

According to an aspect of the invention, there is provided an image processing apparatus. The image processing apparatus includes a first communication unit that wireless-communicates with a terminal apparatus, a second communication unit that is different from the first communication unit and wireless-communicates with the terminal apparatus, a transmitting unit that receives from the terminal apparatus via the second communication unit a suspend instruction to suspend an operation to perform a print instruction that instructs a document to be printed, and suspends the operation to perform the print instruction, and transmits to the terminal apparatus via the first communication unit the print instruction with the operation thereof suspended, and a receiving unit that receives from the terminal apparatus via the second communication unit a resume instruction to resume the operation to perform the print instruction, and receives the print instruction from the terminal apparatus via the first communication unit.

### BRIEF DESCRIPTION OF THE DRAWINGS

Exemplary embodiments of the present invention will be described in detail based on the following figures, wherein:

FIG. 1 generally illustrates an image processing system;

FIG. 2 illustrates a hardware configuration of an image processing apparatus;

FIG. 3 illustrates a hardware configuration of a mobile terminal;

FIG. 4 is a functional block diagram of the image processing apparatus;

FIG. 5 is a functional block diagram of the mobile terminal;

FIG. 6 is a flowchart illustrating an example of a process of the image processing system of a first exemplary embodiment;

FIG. 7 is a flowchart illustrating an example of the process of the image processing apparatus of the first exemplary embodiment;

FIG. 8 is a continuation of the flowchart of FIG. 7;

FIG. 9 is a flowchart illustrating an example of a process of the mobile terminal of the first exemplary embodiment;

FIG. 10 is a flowchart illustrating an example of a process of an image processing system of a second exemplary embodiment;

FIG. 11 illustrates an example of a job management table;

FIG. 12 illustrates an example of a job list;

FIG. 13 is a flowchart illustrating an example of a process performed by the image processing apparatus with a near field communication (NFC) card held over the image processing apparatus in accordance with the second exemplary embodiment;

FIG. 14 is a continuation of the flowchart of FIG. 13;

FIG. 15 is a flowchart illustrating an example of a suspended job selection process;

FIG. 16 is a flowchart illustrating an example of a reception job selection process; and

FIG. 17 is a flowchart illustrating an example of a transmission process of a print job performed by the image processing apparatus of the second exemplary embodiment.

### DETAILED DESCRIPTION

Referring to the drawings, exemplary embodiments of the present invention are described in detail below.

### First Exemplary Embodiment

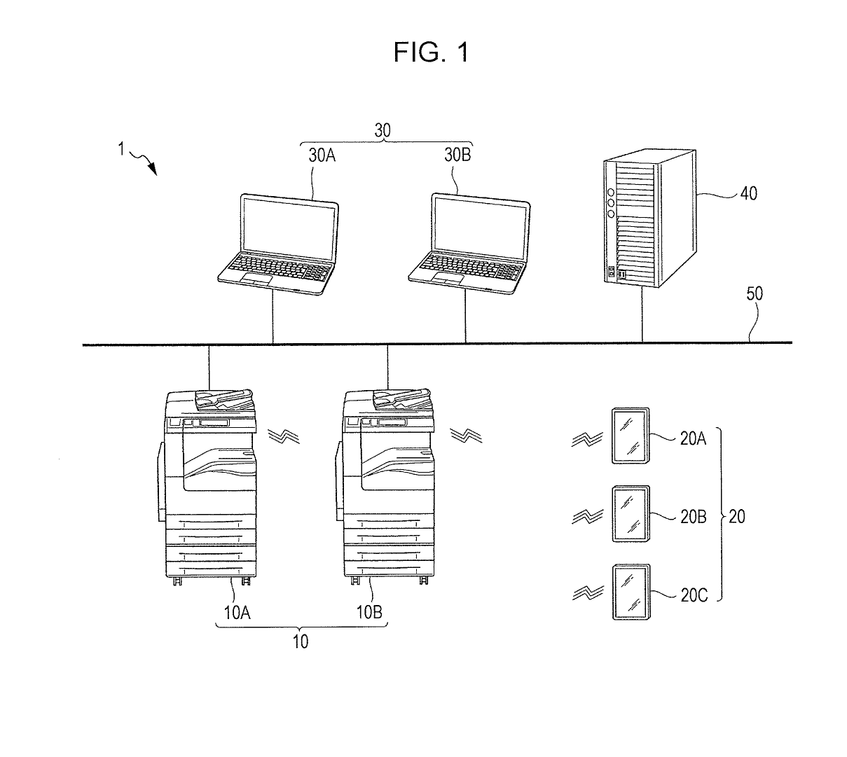

The entire configuration of an image processing system 1 of a first exemplary embodiment is described below. FIG. 1 generally illustrates the image processing system 1. As illustrated in FIG. 1, the image processing system 1 includes an image processing apparatus 10A, an image processing apparatus 10B, a mobile terminal 20A, a mobile terminal 20B, a mobile terminal 20C, an operation terminal 30A, an operation terminal 30B, and a management sever apparatus 40. Wireless communications are performed between each of the image processing apparatus 10A and the image processing apparatus 10B and each of the mobile terminal 20A, the mobile terminal 20B, and the mobile terminal 20C. The image processing apparatus 10A, the image processing apparatus 10B, the operation terminal 30A, the operation terminal 30B, and the management sever apparatus 40 are connected to a network 50 to mutually communicate with each other.

FIG. 1 illustrates the image processing apparatus 10A and the image processing apparatus 10B. The image processing apparatus 10A and the image processing apparatus 10B are collectively referred to as an image processing apparatus 10 when one apparatus is not discriminated from the other. Similarly, FIG. 1 also illustrates the mobile terminal 20A, the mobile terminal 20B, and the mobile terminal 20C. The mobile terminal 20A, the mobile terminal 20B, and the mobile terminal 20C are collectively referred to as a mobile terminal 20 when one terminal is not discriminated from another. Furthermore, FIG. 1 also illustrates the operation terminal 30A and the operation terminal 30B. The operation terminal 30A and the operation terminal 30B are collectively referred to as an operation terminal 30 when one terminal is not discriminated from the other. Although the two image processing apparatuses 10 are illustrated in FIG. 1, three or more image processing apparatuses may be employed. Although the three mobile terminals 20 are illustrated in FIG. 1, four or more mobile terminals 20 may be employed. Although the two operation terminals 30 are illustrated in FIG. 1, three or more operation terminals 30 may be employed.

The image processing apparatus 10 has a scan function, a print function, a copy function, a facsimile function, and other functions. The image processing apparatus 10 forms an image on a recording medium, such a paper sheet, and discharges the resulting recording medium. The image processing apparatus 10 receives a print job from the mobile terminal 20 or the operation terminal 30, and performs a print operation in response to the received print job. The print job includes image data serving as a print target, and a control command in which settings in the print operation are described. The print job is data that serves as a unit of the print operation performed by the image processing apparatus 10.

The mobile terminal 20 is a portable computer that is used to instruct the image processing apparatus 10 to perform a variety of functions. A smart phone, a tablet personal computer, or a laptop computer may be used for the mobile terminal 20.

The operation terminal 30 is a computer that a user uses to view or edit a document file. For example, a laptop computer or a desk top computer may be used for the operation terminal 30. A portable computer, such as a smart phone, may also be used for the operation terminal 30.

The management sever apparatus 40 is a computer that stores a variety of data processed by the image processing system 1.

The network 50 is used as an example of a communication line to link the image processing apparatus 10, the operation terminal 30, and the management sever apparatus 40 for communication, and may be a wired local area network (LAN), for example.

In the exemplary embodiment, the image processing apparatus 10 performs with the mobile terminal 20 near field communication (NFC) or wireless communication (such as Wi-Fi (wireless fidelity) Direct communication) based on another communication standard higher in speed than NFC communication therebetween. NFC is the communication standard in which communication coverage is limited to about 10 cm. Wi-Fi Direct is the standard in accordance with which Wi-Fi terminals directly communicate with each other. In the Wi-Fi Direct connection, each Wi-Fi support device has a function of operating as an access point. The access point is a relay device that relays communications between devices. In the Wi-Fi Direct connection, one of the Wi-Fi support communication devices participating in the network works as an access point, and the device serving as the access point directly communicates with each of the Wi-Fi support devices.

In the Wi-Fi Direct connection, each communication device participating a given network is defined as P2P device, and that network is defined as a P2P group. A P2P device actually operating as an access point in the P2P group is defined as a P2P group owner, and the P2P devices other than the P2P group owner are defined as P2P device clients. Each P2P device detects another P2P device as a connection destination candidate of the Wi-Fi Direct connection by exchanging a signal with the other P2P device, and a P2P group owner is selected from multiple P2P devices.

In the first exemplary embodiment, the image processing apparatus 10 works as the P2P group owner. In the Wi-Fi Direct connection, an upper limit is typically set to the number of P2P device clients concurrently linked to the P2P group owner. In the exemplary embodiment, the upper limit to the number of the mobile terminals 20 concurrently linked to the image processing apparatus 10 (hereinafter referred to as a concurrently connectable number) is three.

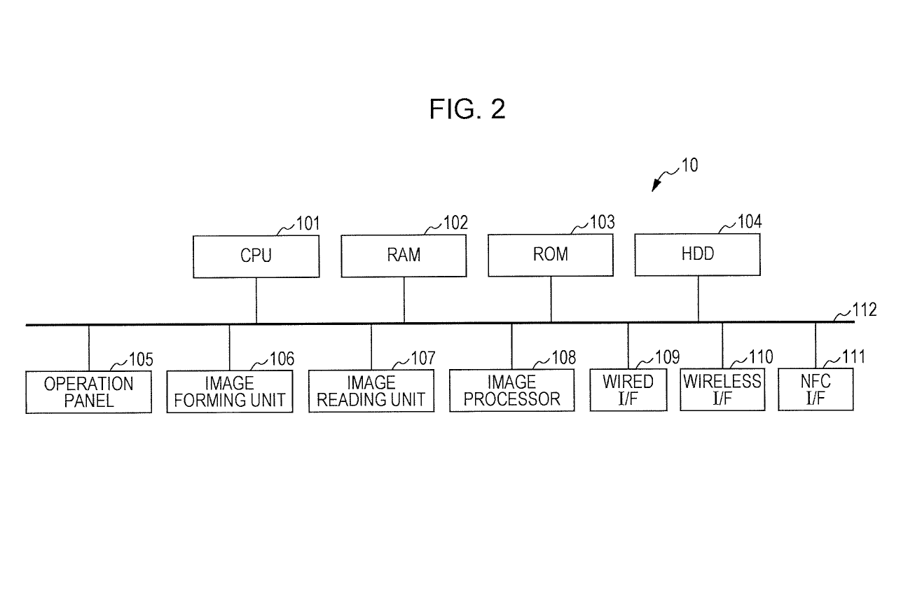

The hardware configuration of the image processing apparatus 10 is described below. FIG. 2 illustrates the hardware configuration of the image processing apparatus 10. As illustrated in FIG. 2, the image processing apparatus 10 includes a central processing unit (CPU) 101, a random-access memory (RAM) 102, a read-only memory (ROM) 103, a hard disk drive (HDD) 104, an operation panel 105, an image forming unit 106, an image reading unit 107, an image processor 108, a wired interface (I/F) 109, a wireless I/F 110, and an NFC I/F 111. These elements are connected to a bus 112, and exchange data via the bus 112.

The CPU 101 executes a variety of software programs, such as an operating system (OS) and applications. The RAM 102 serves as a working memory of the CPU 101. The ROM 103 stores a variety of programs to be executed by the CPU 101. The CPU 101 implements functions of the image processing apparatus 10 by loading the variety of programs stored on the ROM 103 onto the RAM 102.

The HDD 104 is a magnetic disk device that stores image data used in an image forming operation performed by the image forming unit 106.

The program to be executed by the CPU 101 may be supplied in a pre-stored state on the ROM 103. The program to be executed by the CPU 101 may also be supplied in a pre-stored state on one of non-transitory computer recording media including a magnetic recording medium (such as a magnetic tape or a magnetic disk), an optical recording medium (such as an optical disk), a magneto-optical recording medium, and a semiconductor memory. The program may also be supplied to the CPU 101 via the network 50.

The operation panel 105 is a touchpanel that receives a display of a variety of information and an operation input from the user. The operation panel 105 includes a display configured to display a variety of information and a location detecting sheet configured to detect a location touched by a finger of the user or a stylus pen. Devices configured to detect the location of touch may be of any type. For example, such devices may include a device that detects the location in response to pressure applied there and a device that detects the location in response to static electricity of an object touching the location. Input devices, such as a display and a keyboard, may be used in place of the touchpanel.

The image forming unit 106 forms an image on a recording medium. The image forming unit 106 is a printer, for example, and may be an electrophotographic system that forms an image on a recording medium by transferring toner on a photoconductor drum to the recording medium, or an ink-jet system that forms an image on a recording medium by ejecting ink onto the recording medium.

The image reading unit 107 reads an image recorded on a recording medium, and generates image data representing the read image. The image reading unit 107 is a scanner, for example, and is based on a charge-coupled device (CCD) system or a contact image sensor (CIS) system. In the CCD system, a document is irradiated with a light beam, and a light beam reflected from the document is then collected via a lens. In the CIS system, a document is successively irradiated with a light beam from a light emitting diode (LED), and a light beam reflected from the document is received by a CIS sensor.

The image processor 108 performs on the input image data a variety of image processes including color correction and gradation correction. For example, the image processor 108 performs the variety of image processes on the image data read by the image reading unit 107 and the image data stored on the HDD 104, and then outputs the process results to the image forming unit 106.

The wired I/F 109 works as a communication interface that exchanges a variety of data with the operation terminal 30 and the management sever apparatus 40 via the network 50.

The wireless I/F 110 works as a communication interface that includes an antenna for wireless communication with the mobile terminal 20 in the Wi-Fi Direct connection, and exchanges a variety of data with the mobile terminal 20.

The NFC I/F 111 works as a communication interface that includes an antenna for NFC communication with the mobile terminal 20 and exchanges a variety of data with the mobile terminal 20.

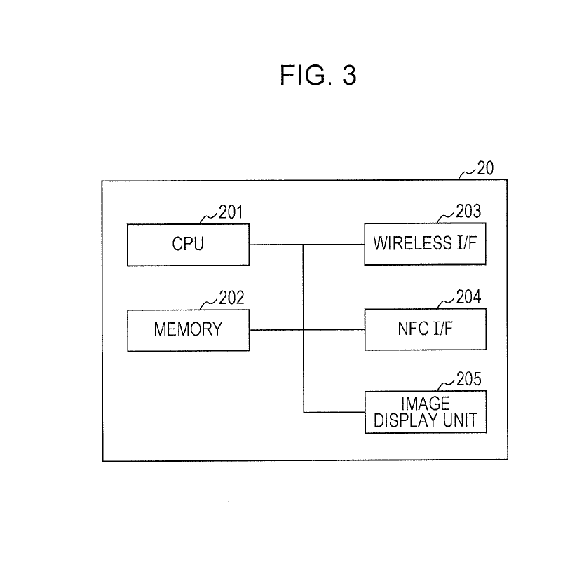

FIG. 3 illustrates the hardware configuration of the mobile terminal 20. As illustrated in FIG. 3, the mobile terminal 20 includes a CPU 201, and a memory 202. The CPU 201 executes a variety of software programs including an OS and applications. The memory 202 includes a storage area that stores the variety of software programs and data for use in the execution of the software programs.

The program to be executed by the CPU 201 may be supplied in a pre-stored state on the memory 202. The program to be executed by the CPU 201 may also be supplied in a pre-stored state on one of non-transitory computer recording media including a magnetic recording medium (such as a magnetic tape or a magnetic disk), an optical recording medium (such as an optical disk), a magneto-optical recording medium, and a semiconductor memory. The program may also be supplied to the CPU 201 via the Internet.

The mobile terminal 20 further includes a wireless I/F 203 and an NFC I/F 204, both configured to communicate with the outside, and an image display unit 205.

The wireless I/F 203 works as a communication interface that includes an antenna for wireless communication with the image processing apparatus 10 in the Wi-Fi Direct connection and exchanges a variety of data with the image processing apparatus 10.

The NFC I/F 204 works as a communication interface that includes an antenna for NFC communication with the image processing apparatus 10 and exchanges a variety of data with the image processing apparatus 10.

The image display unit 205 is a touchpanel, for example. The image display unit 205 includes a liquid-crystal panel and a location detector (not illustrated). When a touching object, such as a finger of the user or a stylus pen, touches the liquid-crystal panel, the location detector detects the touched location. The touchpanel used in the exemplary embodiment is not limited to any particular type. For example, the touchpanel may be of a resistive membrane system or a capacitive sensing system.

The mobile terminal 20 may include an HDD or a flash memory as a memory. The HDD or the flash memory stores data input to a variety of software programs and data output from the variety of software programs. The mobile terminal 20 may further include an input device, such as a keyboard or a mouse.

In the image processing system 1, the mobile terminal 20 and the operation terminal 30 transmit a print job to the image processing apparatus 10 using Wi-Fi Direct wireless communication via the network 50 to print on the image processing apparatus 10.

The management sever apparatus 40 may manage print jobs to be printed on the image processing apparatus 10, re-organize the print jobs in an appropriate sequence, and transmit the re-organized print jobs to the image processing apparatus 10. In this case, the management sever apparatus 40 works as a print server. The management sever apparatus 40 shares a file with the mobile terminal 20 and the operation terminal 30 by managing the file. In this case, the management sever apparatus 40 works as a file server.

The hardware configuration of the operation terminal 30 of FIG. 1 is similar to the image processing apparatus 10 except that the operation terminal 30 does not include the image forming unit 106, the image reading unit 107, the image processor 108, the wireless I/F 110, and the NFC I/F 111.

The function of the image processing apparatus 10 is described below. Upon receiving the print job from the operation terminal 30, the image processing apparatus 10 executes a print operation. When the user holds the mobile terminal 20 over the image processing apparatus 10, the image processing apparatus 10 performs the NFC communication with the mobile terminal 20, and temporarily suspends the operation of the print job. The image processing apparatus 10 establishes a Wi-Fi Direct connection with the mobile terminal 20, and transmits the suspended print job to the mobile terminal 20.

When the user holds the mobile terminal 20 having received the print job from the image processing apparatus 10 over the image processing apparatus 10, the image processing apparatus 10 establishes a Wi-Fi Direct connection with the mobile terminal 20 by performing the NFC communication with the mobile terminal 20. Another image processing apparatus 10 receives the print job from the mobile terminal 20, and resumes the print job that was suspended once for the print operation. In the discussion that follows, a print job that the image processing apparatus 10 suspended is referred to as a suspended job. In the exemplary embodiment, the print job is used as an example of a print instruction and information as to the print instruction.

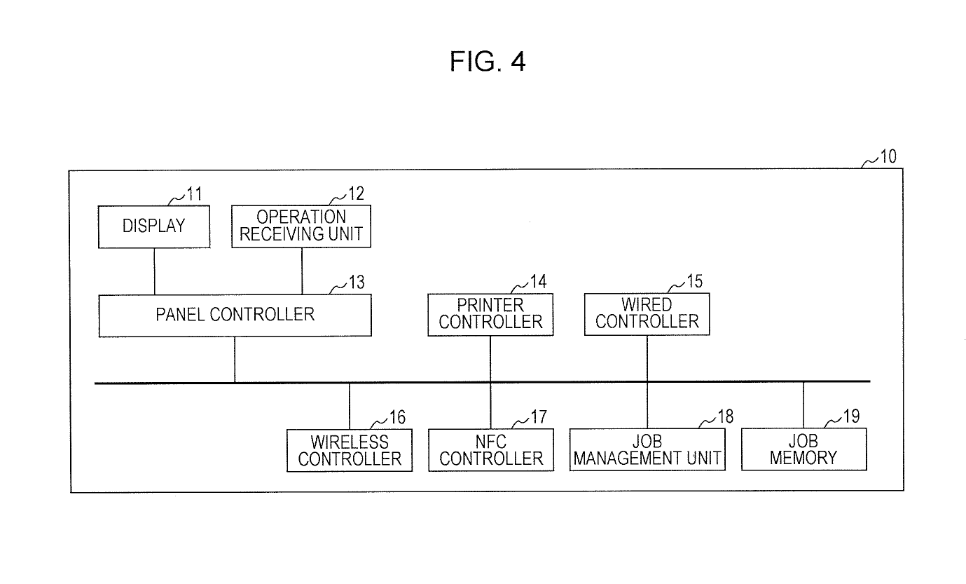

FIG. 4 is a functional block diagram of the image processing apparatus 10. The image processing apparatus 10 includes a display 11, an operation receiving unit 12, a panel controller 13, a printer controller 14, a wired controller 15, a wireless controller 16, an NFC controller 17, a job management unit 18, and a job memory 19.

The display 11, controlled by the panel controller 13, displays on the operation panel 105 a variety of images including a message to the user.

The operation receiving unit 12 receives an operation input from the user who touches the operation panel 105.

The panel controller 13 controls the operation of the display 11 and the operation receiving unit 12.

The printer controller 14 as an example of a printing unit controls the image forming unit 106 and the like, thereby performing the print operation responsive to the print job.

The wired controller 15 exchanges data with another apparatus, such as the operation terminal 30, via the network 50. For example, the wired controller 15 receives the print job from the operation terminal 30.

The wireless controller 16 as an example of a first communication unit establishes the Wi-Fi Direct connection and exchanges data through the wireless communication. For example, the wireless controller 16 receives a print job from the mobile terminal 20 and transmits a print job to the mobile terminal 20.

The NFC controller 17 as an example of a second communication unit or a communication unit exchanges data through the NFC communication. For example, when the NFC I/F 204 in the mobile terminal 20 is held over the NFC I/F 111, the NFC controller 17 exchanges with the mobile terminal 20 information related to a connection condition to establish the Wi-Fi Direct connection with the mobile terminal 20. The information related to the connection condition, as information transmitted from the mobile terminal 20, may be a media access control (MAC) address or a serial number of the mobile terminal 20. The information related to the connection condition, as information transmitted from the image processing apparatus 10, may be the MAC address or service set identifier (SSID) of the image processing apparatus 10. SSID is an identifier that identifies an access point. The NFC controller 17 also receives information that instructs the operation of the suspended job stored on the mobile terminal 20 to resume.

The job management unit 18 controls the operation of the print job, as examples of a transmitting unit, an information transmitting unit, and a print instruction transmitting unit. When the NFC I/F 204 in the mobile terminal 20 is held over the NFC I/F 111, the job management unit 18 determines whether information instructing the operation of the suspended job to resume has been received from the mobile terminal 20. If the information instructing the operation of the suspended job to resume has been received, the job management unit 18 receives the suspended job from the mobile terminal 20 via the wireless controller 16 after establishing the Wi-Fi Direct connection with the mobile terminal 20.

If the information instructing the operation of the suspended job to resume has not been received, the job management unit 18 suspends an operation of a print job having information matching user information associated with the mobile terminal 20 held over, from among the print jobs received from the operation terminal 30 and stored on the job memory 19.

To suspend the operation of the print job, the job management unit 18 performs a pre-process. In the pre-process, the job management unit 18 identifies the user who has printed for the print job received from the operation terminal 30 with reference to the IP address or the like of the operation terminal 30 serving as a transmission source, and attaches information identifying the user (hereinafter referred to as a user ID) to the print job. In the first exemplary embodiment, the operation terminal 30 is provided to each user, and the user ID is determined on each operation terminal 30 which serves as a transmission source of the print job.

Each user has his or her own mobile terminal 20, and each mobile terminal 20 is associated in advance with a respective user ID. The job management unit 18 receives from the mobile terminal 20 held over the user ID associated with the mobile terminal 20, and determines whether the print job having the user ID matching the received user ID is stored on the job memory 19. If the print job having the user ID matching the received user ID is stored on the job memory 19, the job management unit 18 determines that there is a print job that is to be suspended, and notifies the mobile terminal 20 of the presence of such print job. The job management unit 18 thus suspends the operation of the print job.

The print job that is to be suspended is a print jot that is under way on the image processing apparatus 10, or a print job that is waiting for a print operation. The print job that is under way indicates a print job which is in the middle of forming an image on a paper sheet or the like, or a print job that is temporarily suspended because of an out-of-paper state or paper jamming. The print job that is waiting for the print operation is a print job which has not started yet because another print job is now under way.

When the operation of the print job is suspended, the job management unit 18 transmits the print job that is suspended in operation (namely, suspended job) to the mobile terminal 20 via the wireless controller 16 after establishing the Wi-Fi Direct connection with the mobile terminal 20.

The job memory 19 stores the print job received from the operation terminal 30 and the print job (suspended job) received from the mobile terminal 20. Each print job received from the operation terminal 30 and stored on the job memory 19 has information identifying the print job (hereinafter referred to as a job ID) attached thereto by the job management unit 18.

In response to an instruction from the CPU 101, the image processing apparatus 10 implements the functions of the panel controller 13, the printer controller 14, the wired controller 15, the wireless controller 16, the NFC controller 17, and the job management unit 18. The display 11 and the operation receiving unit 12 may be implemented by the operation panel 105, for example. The wired controller 15 may be implemented by the wired I/F 109. The wireless controller 16 may be implemented by the wireless I/F 110. The NFC controller 17 may be implemented by the NFC I/F 111. The job memory 19 may be implemented by the HDD 104.

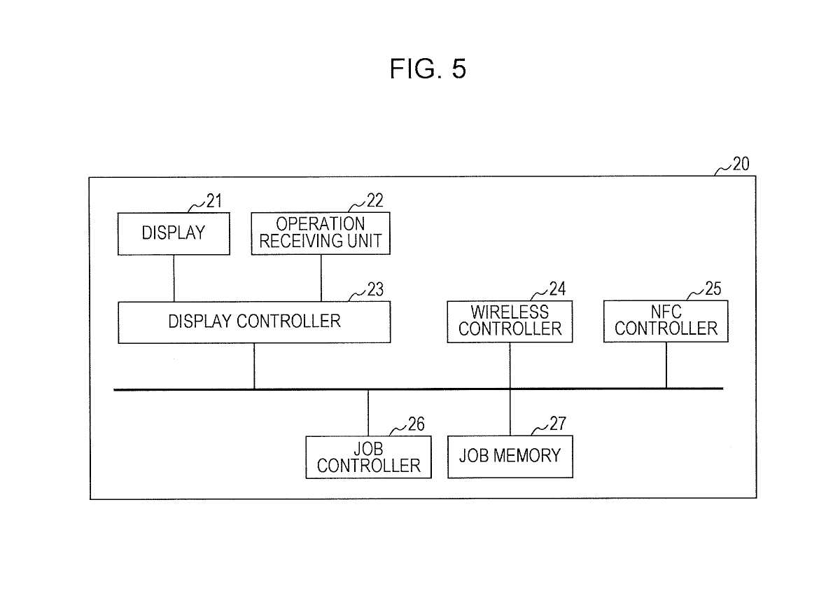

The function and configuration of the mobile terminal 20 are described below. FIG. 5 is a functional block diagram of the mobile terminal 20. The mobile terminal 20 includes a display 21, an operation receiving unit 22, a display controller 23, a wireless controller 24, an NFC controller 25, a job controller 26, and a job memory 27. In the exemplary embodiment, the mobile terminal 20 is used as an example of a terminal apparatus.

The display 21, controlled by the display controller 23, displays on the image display unit 205 a variety of images, such as a message to the user.

The operation receiving unit 22, as an example of a receiving unit, receives an operation input from the user who touches the image display unit 205.

The display controller 23 controls the operation of the display 21 and the operation receiving unit 22.

The wireless controller 24, as an example of a wireless communication unit, establishes the Wi-Fi Direct connection and exchanges data through wireless communications. For example, the wireless controller 24 receives a print job from the image processing apparatus 10 and transmits a print job to the image processing apparatus 10.

The NFC controller 25, as an example of the wireless communication unit, transmits and receives data through the NFC communication. For example, when the NFC I/F 204 is held over the NFC I/F 111 in the image processing apparatus 10, the NFC controller 25 transmits and receives information related to a connection condition to establish the Wi-Fi Direct connection with the image processing apparatus 10. Also, the NFC controller 25 transmits information to instruct the operation of the print job stored on the mobile terminal 20 to resume.

The job controller 26, as an example of an acquisition unit and an instructing unit, controls the operation of the print job. When the NFC I/F 204 is held over the NFC I/F 111 in the image processing apparatus 10, the job controller 26 determines whether the suspended job is stored on the job memory 27. If the suspended job is not stored on the job memory 27, the job controller 26 transmits the user ID associated with the mobile terminal 20 to the image processing apparatus 10 and instructs the image processing apparatus 10 to suspend the operation of the print job. If the job controller 26 is notified by the image processing apparatus 10 that a print job as a suspension target is present, the job controller 26 receives the suspended job from the image processing apparatus 10 via the wireless controller 24 after establishing the Wi-Fi Direct connection with the image processing apparatus 10. The job controller 26 stores the received suspended job on the job memory 27.

If the suspended job is stored on the job memory 27, the job controller 26 transmits to the image processing apparatus 10 information instructing the image processing apparatus 10 to resume the operation of the suspended job, together with the user ID associated with the mobile terminal 20. After establishing the Wi-Fi Direct connection with the image processing apparatus 10, the job controller 26 transmits the suspended job to the image processing apparatus 10 via the wireless controller 24.

The job memory 27, as an example of a memory, stores the print job (the suspended job) received from the image processing apparatus 10.

In response to an instruction from the CPU 201, the mobile terminal 20 implements the function of the display controller 23, the wireless controller 24, the NFC controller 25, and the job controller 26. The display 21 and the operation receiving unit 22 are implemented by the image display unit 205. The wireless controller 24 is implemented by the wireless I/F 203. The NFC controller 25 is implemented by the NFC I/F 204. The job memory 27 is implemented by the memory 202 and the HDD.

The operation of the Wi-Fi Direct connection to be established between the image processing apparatus 10 and the mobile terminal 20 is described below. With the mobile terminal 20 held over the image processing apparatus 10, the NFC communication automatically starts between the image processing apparatus 10 and the mobile terminal 20. As described above, the information related to the connection condition to establish the Wi-Fi Direct connection, such as the MAC address and SSID, is transmitted and received. The NFC controller 17 in the image processing apparatus 10 operates in a card emulation mode, and successively replies in response to a data acquisition request from the NFC controller 25 in the mobile terminal 20 that operates in a reader-writer mode. The information related to the connection condition is transmitted and received in an NFC data exchange format (NDEF) that is a data format typically used in the NFC communication. The image processing apparatus 10 is then selected as the P2P group owner.

The mobile terminal 20 compares the acquired SSID with the SSID of the P2P device detected as a transmission partner candidate in the NFC communication. The mobile terminal 20 attempts to establish the Wi-Fi Direct connection with the P2P device having the matched SSID, namely, the image processing apparatus 10. The image processing apparatus 10 and the mobile terminal 20 perform an operation to establish the Wi-Fi Direct connection, and thus establishes the connection between the apparatuses without the input operation from the user. The mobile terminal 20 switches the wireless communication from the NFC controller 25 to the wireless controller 24. If an authentication operation involving the user input is to be performed in the establishment of the Wi-Fi Direct connection, the user performs the input operation on the image processing apparatus 10 and the mobile terminal 20.

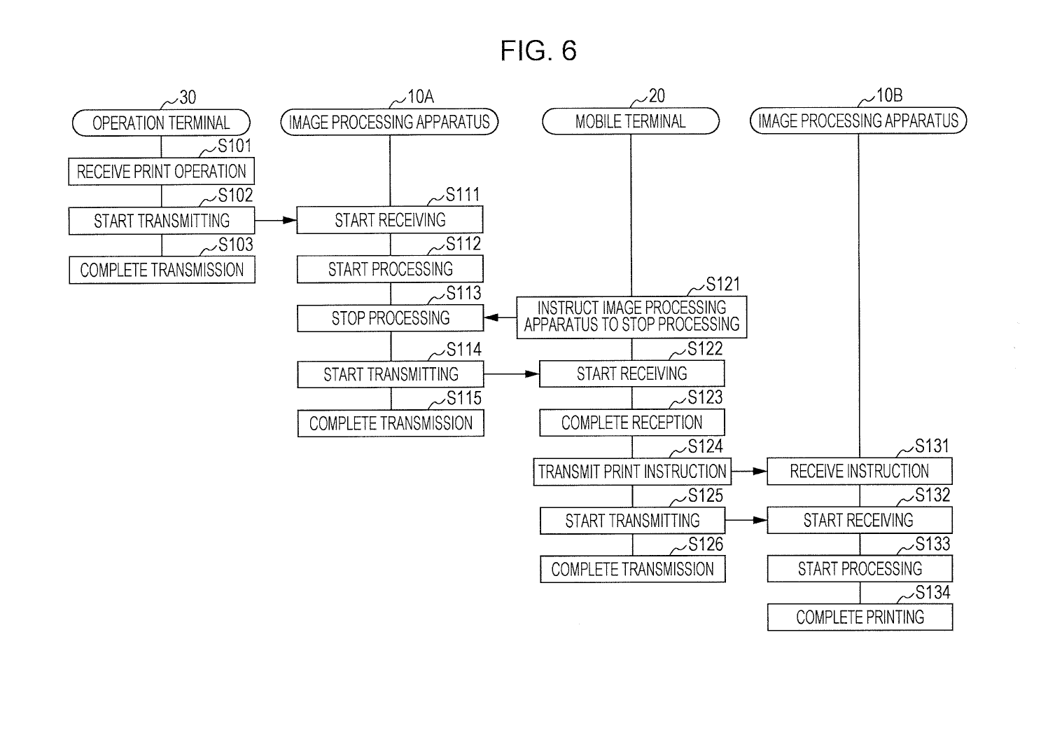

The operation of the image processing system 1 is described. FIG. 6 is a flowchart illustrating an example of an operation of the image processing system of the first exemplary embodiment. In the example of FIG. 6, a user A holds the mobile terminal 20 over the image processing apparatus 10A. After the image processing apparatus 10A suspends the operation of a print job, the user A holds the mobile terminal 20 over the image processing apparatus 10B to resume the suspended print job.

The user A performs an operation to print using the operation terminal 30. The operation terminal 30 receives the operation to print (step S101). The user A also selects a document or an image to be printed, and selects the image processing apparatus 10A as an output destination image processing apparatus 10. The operation terminal 30 generates the print job in response to the operation of the user A, and transmits the generated print job to the image processing apparatus 10A (step S102). When the transmission of the print job is complete (step S103), the operation of the operation terminal 30 is complete.

Upon receiving the print job from the operation terminal 30 (step S111), the image processing apparatus 10A starts a print operation responsive to the print job (step S112). If the image processing apparatus 10A is in the middle of performing the print operation for another print job, the image processing apparatus 10A stores the print job received in step S111 as a print job waiting for the print operation. If multiple print jobs are received in step S111, the image processing apparatus 10A sets the remaining print jobs to be in a print waiting status and then prints them one by one in sequence.

When the user A holds the mobile terminal 20 over the image processing apparatus 10A, the mobile terminal 20 transmits the user ID of the user A associated with the mobile terminal 20 to the image processing apparatus 10A and instructs the image processing apparatus 10A to suspend the operation (step S121). The image processing apparatus 10A determines whether a print job having the same user ID as the transmitted user ID is present from among the print job under way and the print jobs waiting for the print operation. In the example of FIG. 6, the user ID attached to the print job received in step S111 and the user ID associated with the mobile terminal 20 match each other and are the user ID of the user A. The image processing apparatus 10A thus suspends the operation of the print job received in step S111 (step S113).

The image processing apparatus 10A transmits the suspended print job as a suspended job to the mobile terminal 20 after establishing the Wi-Fi Direct connection with the mobile terminal 20 (step S114). When the transmission of the suspended job is complete (step S115), the image processing apparatus 10A completes the process thereof. The mobile terminal 20 starts receiving the suspended job (step S122), and completes the reception of the suspended job (step S123). When the user A holds the mobile terminal 20 over the image processing apparatus 10B, the mobile terminal 20 transmits to the image processing apparatus 10B information instructing the image processing apparatus 10B to resume the operation of the suspended job and then instructs the image processing apparatus 10B to resume the print job (step S124). For example, the mobile terminal 20 transmits the job ID of the suspended job as the information instructing the image processing apparatus 10B to resume the operation of the suspended job. The job ID of the suspended job is interpreted as information indicating that the mobile terminal 20 stores the suspended job. The image processing apparatus 10B receives an instruction to resume printing from the mobile terminal 20 (step S131).

The mobile terminal 20 transmits the suspended job to the image processing apparatus 10B after establishing the Wi-Fi Direct connection with the image processing apparatus 10B (step S125). When the transmission of the suspended job is complete (step S126), the mobile terminal 20 completes the process thereof. Upon receiving the suspended job from the mobile terminal 20 (step S132), the image processing apparatus 10B starts the print operation responsive to the suspended job (step S133). Even if the image processing apparatus 10A has printed part of the suspended job, the image processing apparatus 10B performs the print operation starting with the first page. When the print operation responsive to the suspended job is complete (step S134), the image processing apparatus 10B completes the process thereof.

In step S133, the image processing apparatus 10B does not necessarily have to start printing with the first page. For example, the image processing apparatus 10A may attach, to the suspended job, status information for each page as to whether the page is fully printed or unfinished, and then transmits the suspended job. The image processing apparatus 10B prints unfinished pages only by referencing the information attached to the suspended job. Alternatively, whether to print starting with the first page or to print the unfinished page only may be determined on a per user ID basis, and this setting may be stored on the image processing apparatus 10. If the image processing apparatus 10 is configured to print the unfinished page only, the image processing apparatuses 10 may be changed on a per page basis. For example, the user may suspend only a page that is desired to be printed in color and then print the page on an image processing apparatus 10 having a color print function. After color printing, the user may print the subsequent pages back on the image processing apparatus 10 having no color print function.

Whether to print starting with the first page or to print the unfinished page only may be determined by the manner in which the user holds the mobile terminal 20. For example, whether to print starting with the first page or to print the unfinished page only may be determined depending on the number of touches on the mobile terminal 20 within a specific period of time or a duration of time throughout the user continuously touches the mobile terminal 20.

In addition to printing starting with the first page or printing the unfinished page only, the image processing apparatus 10B may print a page selected by the user, or a page selected by the user and pages subsequent to the selected page.

If the image processing apparatus 10A is configured to successively delete data of pages that have undergone printing, information of the unfinished pages only is transmitted to the mobile terminal 20. In such a case, the image processing apparatus 10B prints the unfinished pages only.

When the suspended job is received from the mobile terminal 20, the image processing apparatus 10B may perform the operation of the suspended job with higher priority than other print jobs the image processing apparatus 10B has now.

In the example of FIG. 6, the apparatus that transmits the suspended job is the image processing apparatus 10A and the apparatus that receives the suspended job is the image processing apparatus 10B. Alternatively, the image processing apparatus 10A and the image processing apparatus 10B may be the same apparatus.

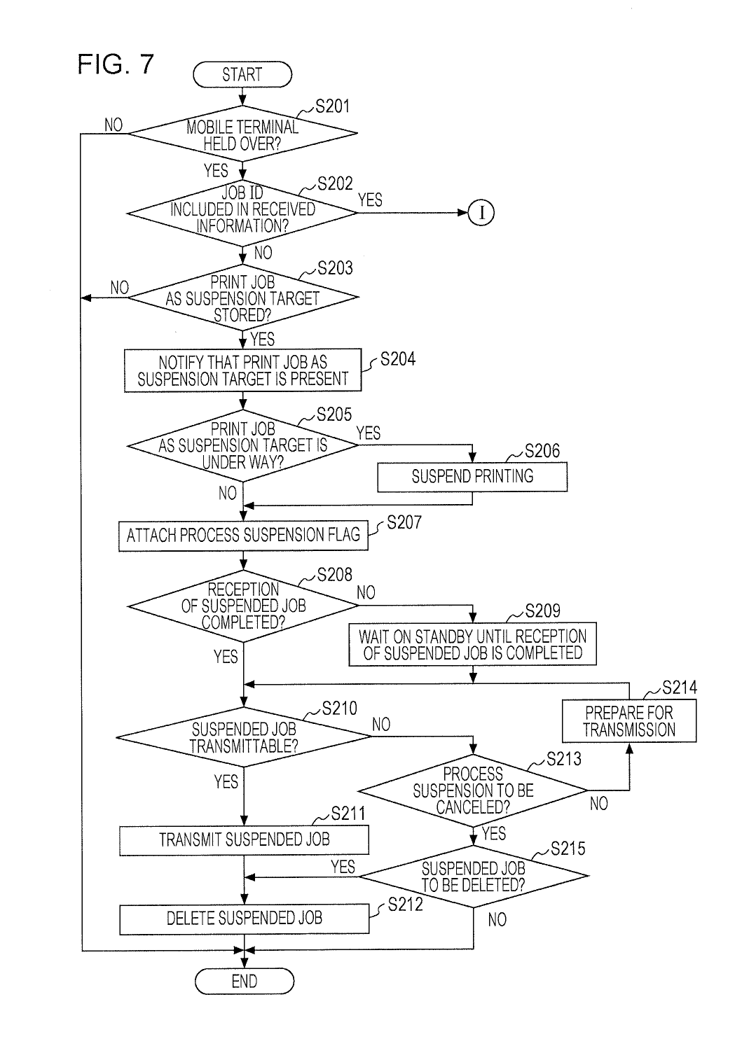

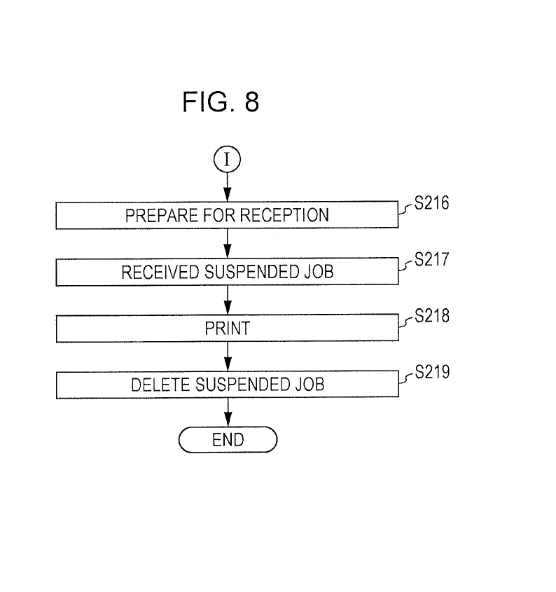

The operation of the image processing apparatus 10 is described below. FIG. 7 and FIG. 8 are flowcharts of the operation of the image processing apparatus 10 of the first exemplary embodiment. In the example of FIG. 7 and FIG. 8, the image processing apparatus 10 receives the job ID of the suspended job from the mobile terminal 20 as the information instructing the operation of the suspended job to resume.

The NFC controller 17 determines whether the mobile terminal 20 is held over the NFC I/F 111 (step S201). If the mobile terminal 20 is not held over (no branch from step S201), processing ends. If the mobile terminal 20 is held over (yes branch from step S201), the NFC controller 17 performs the NFC communication to receive the information stored on the mobile terminal 20. If the mobile terminal 20 stores the suspended job, the image processing apparatus 10 receives the user ID associated with the mobile terminal 20 and the job ID of the suspended job. On the other hand, if the mobile terminal 20 stores no suspended job, the image processing apparatus 10 receives the user ID while not receiving the job ID.

The job management unit 18 determines whether the information received from the mobile terminal 20 includes the job ID (step S202). If the job ID is included in the information (yes branch from step S202), the image processing apparatus 10 performs the print operation responsive to the suspended job, and processing proceeds to step S216 to be discussed below. If no job ID is included in the information (no branch from step S202), the job management unit 18 determines whether the job memory 19 stores the print job as a suspension target (step S203). If the print job having the same user ID as the user ID received from the mobile terminal 20 is present from among the print jobs under way or waiting for the print operation, the job management unit 18 determines that the print job as the suspension target is present.

If there is no print job as a suspension target (no branch from step S203), the job management unit 18 notifies the mobile terminal 20 that there is no print job as a suspension target, and ends the process. If a print job as a suspension target is present (yes branch from step S203), the job management unit 18 notifies the mobile terminal 20 that a print job as a suspension target is present (step S204). The job management unit 18 determines whether the printing of the print job as the suspension target is under way (step S205). If the printing of the print job is under way (yes branch from S205), the printer controller 14 suspends the print operation (step S206). If the printing of the print job is not under way (no branch from S205), or subsequent to step S206, the job management unit 18 attaches to the print job as the suspension target a process suspension flag to indicate the suspension of the print job (step S207). The print job having the process suspension flag attached thereto is handled as a suspended job.

The job management unit 18 determines whether the suspended job has been received from the operation terminal 30 (step S208). If the suspended job has not been received (no branch from S208), the job management unit 18 waits on standby until the reception is complete (step S209). If the suspended job has been received (yes branch from S208), or subsequent to step S209, the job management unit 18 determines whether the suspended job is transmittable to the mobile terminal 20 (step S210). If the wireless controller 16 has established the Wi-Fi Direct connection with the mobile terminal 20, the job management unit 18 determines that the suspended job is transmittable.

If the suspended job is transmittable (yes branch from S210), the job management unit 18 transmits the suspended job to the mobile terminal 20 via the wireless controller 16 (step S211). The job management unit 18 deletes the suspended job from the job memory 19 (step S212). On the other hand, if the suspended job is not transmittable (no branch from S210), the job management unit 18 determines whether to cancel the suspension of the operation of the suspended job (step S213). For example, a message prompting the user to determine whether to cancel the suspension of the process is displayed on the operation panel 105 in the image processing apparatus 10 or the image display unit 205 in the mobile terminal 20. The user thus performs this selection operation. The job management unit 18 determines whether to cancel the suspension based on the user selection.

If it is determined that the suspension of the process is not to be canceled (no branch from S213), the wireless controller 16 prepares for the transmission of the suspended job (step S214). More specifically, the wireless controller 16 performs an operation to establish the Wi-Fi Direct connection between the image processing apparatus 10 and the mobile terminal 20. Processing returns to step S210. If it is determined that the suspension of the process is to be canceled (yes branch from S213), the job management unit 18 determines whether to delete the suspended job (step S215). In the same way as in step S213, the job management unit 18 determines whether to delete the suspended job in response to the user selection. If it is determined that the suspended job is to be deleted (yes branch from S215), processing proceeds to step S212. If it is determined that the suspended job is not to be deleted (no branch from S215), processing thus ends.

If the job ID is included in the received information in step S202 (yes branch from step S202), the wireless controller 16 prepares for the reception of the print job (step S216). More specifically, the wireless controller 16 performs an operation to establish the Wi-Fi Direct connection between the image processing apparatus 10 and the mobile terminal 20. If the Wi-Fi Direct connection is established, the job management unit 18 receives the suspended job from the mobile terminal 20 via the wireless controller 16 (step S217), and stores the suspended job on the job memory 19. The printer controller 14 performs the print operation for the received suspended job (step S218). The job management unit 18 deletes the suspended job having undergone the print operation from the job memory 19 (step S219). Proceeding thus ends.

If multiple print jobs are present as suspension targets in step S203, the user may select a print job that is to be actually suspended. For example, the operation panel 105 in the mobile terminal 20 or the image display unit 205 in the mobile terminal 20 may display the information of the print jobs as the suspension targets, and the user may select a print job the user actually wishes to suspend.

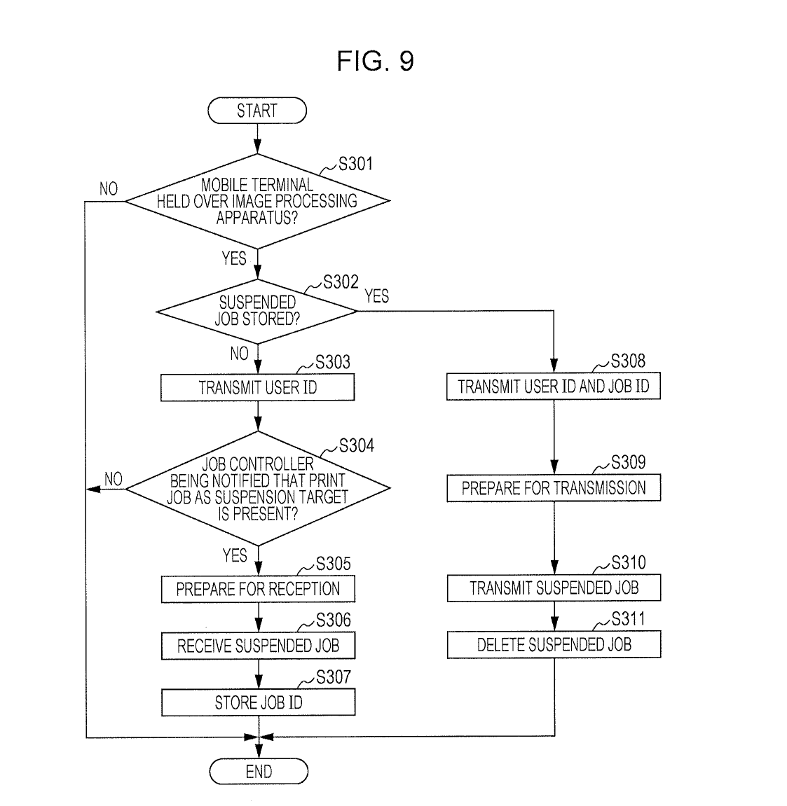

The operation of the mobile terminal 20 is described below. FIG. 9 is a flowchart illustrating an example of the operation of the mobile terminal 20 of the first exemplary embodiment. In FIG. 9, in the same way as in FIG. 7 and FIG. 8, the mobile terminal 20 transmits to the image processing apparatus 10 the job ID of the suspended job as the information instructing the operation of the suspended job to resume.

The NFC controller 25 determines whether the mobile terminal 20 is held over the image processing apparatus 10 (step S301). If the mobile terminal 20 is not held over the image processing apparatus 10 (no branch from S301), processing ends. If the mobile terminal 20 is held over the image processing apparatus 10 (yes branch from S301), the job controller 26 determines whether the suspended job is stored on the job memory 27 (step S302). If the suspended job is not stored (no branch from S302), the job controller 26 transmits the user ID associated with the mobile terminal 20 to the mobile terminal 20 via the NFC controller 25 (step S303) to instruct the image processing apparatus 10 to suspend the operation of the print job.

The job controller 26 determines whether the image processing apparatus 10 has notified the job controller 26 that a print job as a suspension target is present (step S304). If the job controller 26 has been notified that no print job as a suspension target is present (no branch from S304), processing ends. If the job controller 26 has been notified that a print job as a suspension target is present (yes branch from S304), the wireless controller 24 prepares for the reception of the print job (step S305). More specifically, the wireless controller 24 performs an operation to establish the Wi-Fi Direct connection between the mobile terminal 20 and the image processing apparatus 10. When the Wi-Fi Direct connection is established, the job controller 26 receives the suspended job from the image processing apparatus 10 via the wireless controller 24 (step S306), and stores the received suspended job on the job memory 27. The job controller 26 stores the job ID of the received suspended job on the job memory 27 (step S307). Processing thus ends.

If the suspended job is stored in step S302 (yes branch from S302), the job controller 26 transmits to the image processing apparatus 10 the user ID associated with the mobile terminal 20 and the job ID of the suspended job via the NFC controller 25 (step S308) and instructs the image processing apparatus 10 to resume the operation of the suspended job. The wireless controller 24 prepares for the transmission of the suspended job (step S309). More specifically, the wireless controller 24 performs an operation to establish the Wi-Fi Direct connection between the mobile terminal 20 and the image processing apparatus 10. When the Wi-Fi Direct connection is established, the job controller 26 transmits the suspended job to the image processing apparatus 10 via the wireless controller 24 (step S310). The job controller 26 then deletes the suspended job from the job memory 27 (step S311). Processing thus ends.

If the suspended job is stored (yes branch from S302), the job controller 26 is to transmit the user ID and the job ID. A determination step to determine whether to additionally retrieve a print job from the image processing apparatus 10 may be performed. In such a case, the operation panel 105 or the image display unit 205 in the mobile terminal 20 may display a message prompting the user to decide whether to additionally retrieve a print job. If the user decides to additionally retrieve the print job, processing proceeds to step S303. If the user decides not to additionally retrieve the print job, processing proceeds to step S308.

If the suspended job is stored (yes branch from S302), the number of suspended jobs may be plural. In that case, the user may select a print job to be transmitted to the image processing apparatus 10 from the multiple suspended jobs. The operation panel 105 or the image display unit 205 in the mobile terminal 20 may display the information of the suspended jobs, and the user may select the print job the user may wish to resume. The selected suspended job is then transmitted to the image processing apparatus 10.

As described above, the operation of the print job is suspended when the user holds the mobile terminal 20 over the image processing apparatus 10 in the image processing system 1. If the user further holds the mobile terminal 20 over another image processing apparatus 10, the operation of the print job resumes.

If one image processing apparatus 10 the user currently uses becomes inoperative because of the occurrence of an operation error, an out-of-paper state, or a fault in the image processing apparatus 10, another the image processing apparatus 10 may be used. This arrangement reduces the workload on the user in comparison with the case in which the user performs an operation to print using the operation terminal 30 again. Another the image processing apparatus 10 may be used if the user wishes to change to a different output location or has to wait on standby for printing because another user is currently using the image processing apparatus 10. In such a case, as well, this arrangement cuts down on the workload of the user.

The user simply carries the mobile terminal 20 having received the print job. For example, the user may quit the operation of the print job at a company office, and may then resume the print job at a business trip destination. The operation to resume the print job may be performed on the image processing apparatuses 10 arranged over different networks.

The suspended print job, once transmitted to the mobile terminal 20, is deleted from the image processing apparatus 10. The data of the print job is not left on the image processing apparatus 10, and leak of the information is controlled.

### Second Exemplary Embodiment

A second exemplary embodiment is described below. In the first exemplary embodiment, the mobile terminal 20 stores the suspended job, and the image processing apparatus 10 resumes the print operation after receiving the print job from the mobile terminal 20. In the second exemplary embodiment, the print operation is suspended and resumed using the mobile terminal 20 or the NFC card having no memory capacity enough to store the print job. More specifically, the mobile terminal 20 or an NFC card is used to instruct the print operation to be suspended or resumed, and the transmission and reception of the print job are directly performed between the image processing apparatuses 10. The NFC card is a card having the NFC function, and is distributed to each user in the same manner as the mobile terminal 20. Each NFC card is associated with a respective user ID. In the second exemplary embodiment, the NFC card or the mobile terminal 20 is used for an example of a terminal apparatus. In the discussion that follows, the NFC card is used. If the mobile terminal 20 having no memory capacity enough to store the print job is used, the process similar to the process described below may be performed.

In the second exemplary embodiment, the job memory 19 in the image processing apparatus 10 stores a table listing a user ID, a job ID, and the status of an operation, registered therein (hereinafter referred to as a job management table). The NFC card receives information of the suspended job from the image processing apparatus 10 and stores the list having the received information registered therein (hereinafter referred to as a job list). The job management table and the job list are described in detail below.

The hardware configuration of the NFC card is similar to the mobile terminal 20 of FIG. 3 except that the NFC card is without the wireless I/F 203 and the image display unit 205. In the second exemplary embodiment, elements identical to those of the first exemplary embodiment are designated with the same reference numerals and the discussion thereof is omitted herein.

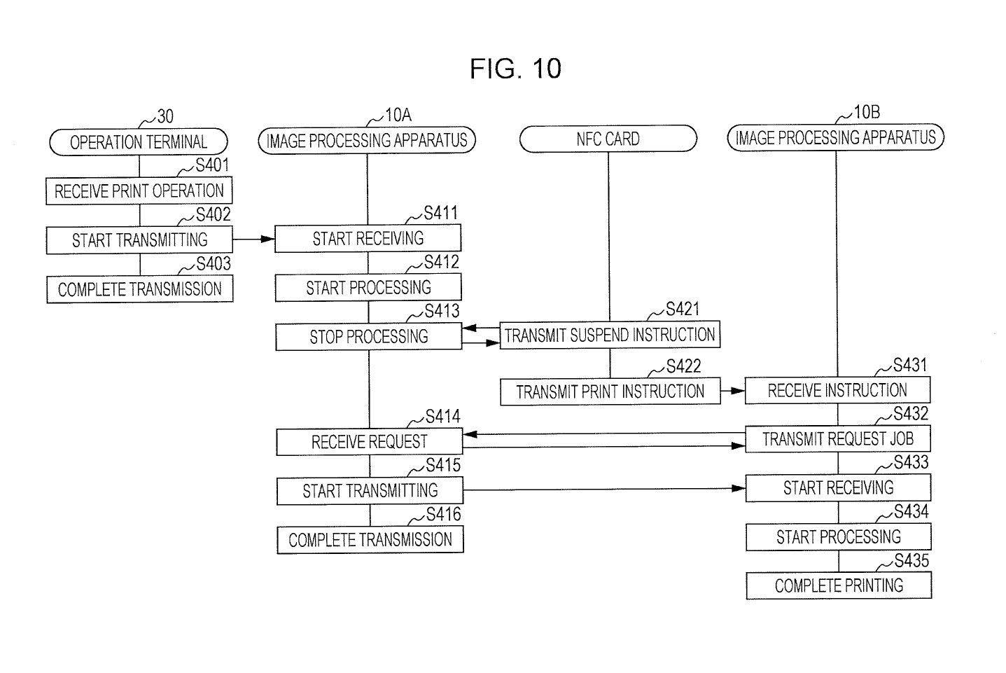

The operation of the image processing system 1 is described below. FIG. 10 is a flowchart illustrating an example of the operation of the image processing system 1 of the second exemplary embodiment. Referring to FIG. 10, the user A holds the NFC card over the image processing apparatus 10A, and the image processing apparatus 10A suspends the operation of the print job. The user A then holds the NFC card over the image processing apparatus 10B, and the image processing apparatus 10B resumes the operation of the suspended print job.

The user A performs an operation to print using the operation terminal 30. The operation terminal 30 receives the operation to print (step S401). The operation terminal 30 generates the print job in response to the operation of the user A, and transmits the generated print job to the image processing apparatus 10A (step S402). When the transmission of the print job is complete (step S403), the operation of the operation terminal 30 is complete.

Upon receiving the print job from the operation terminal 30 (step S411), the image processing apparatus 10A starts a print operation responsive to the print job (step S412). When the user A holds the NFC card over the image processing apparatus 10A, the NFC card transmits to the image processing apparatus 10A the user ID of the user A associated with the NFC card to instruct the image processing apparatus 10A to suspend the operation of the print job (step S421) if the information of the print job is not registered on the job list. The image processing apparatus 10A determines whether a print job having the same user ID as the transmitted user ID is stored on the job memory 19 from among the print job under way and the print jobs waiting for the print operation.

In the example of FIG. 10, the user ID attached to the print job received in step S411 and the user ID associated with the NFC card match each other and are the user ID of the user A. The image processing apparatus 10A thus suspends the operation of the print job received in step S411 (step S413). The image processing apparatus 10A transmits to the NFC card the address thereof (such as an IP address or a MAC address), and the print job with the process thereof suspended (namely, the suspended job). The NFC card registers the received address and job ID on the job list. In the second exemplary embodiment, the job ID is an example of identification information. The address is an example of recognition information. The print job is an example of a print instruction. The address and the job ID are examples of information of the print instruction.

When the user A holds the NFC card over the image processing apparatus 10B, the NFC card transmits to the image processing apparatus 10B the user ID associated with the NFC card, and the address and job ID registered in the job list to instruct the image processing apparatus 10B to resume the print operation (step S422). The image processing apparatus 10B receives the user ID, address, and job ID from the NFC card and accepts the instruction to resume the printing operation (step S431). The image processing apparatus 10B transmits the user ID and the job ID received from the NFC card to the image processing apparatus 10 having the received address attached thereto, namely, the image processing apparatus 10A, and requests the print job from the image processing apparatus 10A(step S432).

The image processing apparatus 10A receives the user ID and job ID from the image processing apparatus 10B and accepts the request for the print job (step S414). The image processing apparatus 10A notifies the image processing apparatus 10B that the request has been received. In the second exemplary embodiment, the image processing apparatus 10A and the image processing apparatus 10B communicate with each via the network 50. The present invention is not limited to this method. For example, the communication may be performed using the Wi-Fi Direct connection. Data is exchanged after the Wi-Fi Direct connection is established.

The image processing apparatus 10A references the jog management table, and transmits to the image processing apparatus 10B the suspended job corresponding to the user ID and job ID received from the image processing apparatus 10B (step S415). When the transmission of the suspended job is complete (step S416), the image processing apparatus 10A completes the process thereof. Upon receiving the suspended job from the image processing apparatus 10A (step S433), the image processing apparatus 10B starts the print operation responsive to the suspended job (step S434). When the print operation responsive to the suspended job is complete (step S435), the image processing apparatus 10B completes the process thereof.

If the image processing apparatus 10A transmitting the suspended job and the image processing apparatus 10B receiving the suspended job are the same apparatus, the suspend and resume operation are performed without transmitting and receiving the print job.

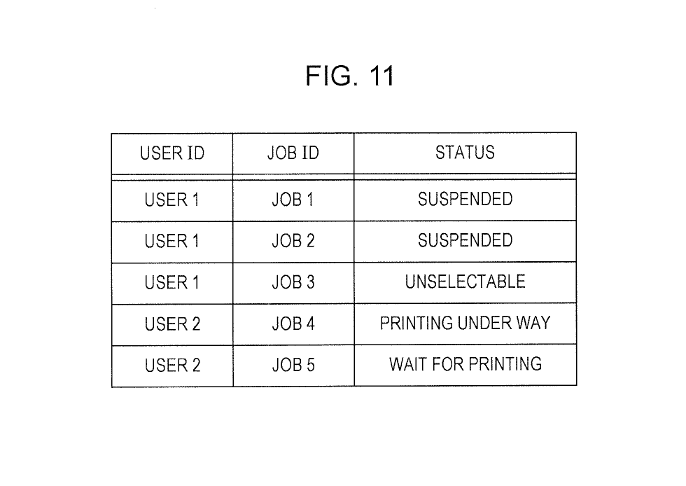

The job management table stored on the job memory 19 is described below. FIG. 11 illustrates an example of the job management table. A “user ID” identifies a user who has performed the print operation, and is attached to the print job. A “job ID” is attached to the print job by the image processing apparatus 10. A “status” indicates a status of the print job.

Referring to FIG. 11, user 1 or user 2 is attached to each print job as the user ID. Different job 1 through job 5 are respectively attached to the print jobs as the job IDs. For convenience of explanation, job 1 through job 5 are listed in FIG. 11. To discriminate the job ID from a job ID attached by another image processing apparatus 10, the job ID may include any character string or a time stamp.

The statuses of the print jobs registered herein include “suspended”, “unselectable”, “printing under way”, and “waiting for printing”. The “suspended” status indicates the print job whose operation is suspended, and which is a target to be transmitted to another image processing apparatus 10. The “unselectable” status indicates the print job whose operation is suspended, but is not a target to be transmitted to another image processing apparatus 10. Since the NFC card in the second exemplary embodiment has a limited memory capacity, the upper limit is set on the number of print jobs that are suspended, from among the print jobs having the same user ID attached thereto on the image processing apparatus 10. A print job above the upper limit is registered as “unselectable”. In the example of FIG. 11, the upper limit is “2”, and job 1 and job 2 are “suspended”, and job 3 is “unselectable”. The “printing under way” status indicates the print job that is currently printed, and the “waiting for printing” status indicates the print job that is waiting for the print operation.

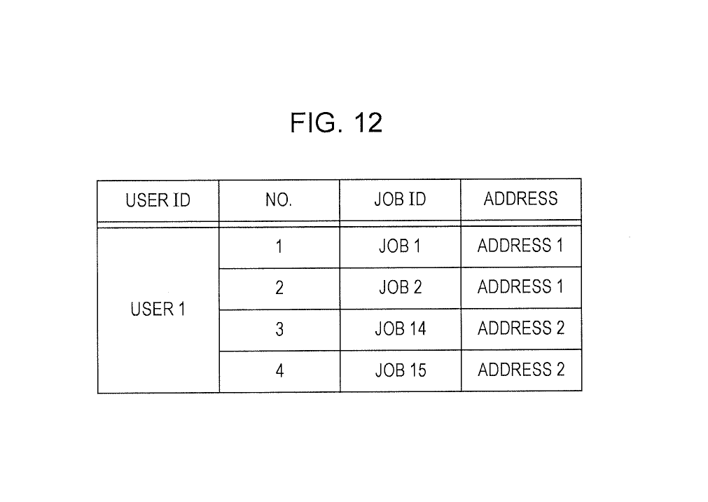

The job list stored on the NFC card is described below. FIG. 12 illustrates an example of the job list. In the example of FIG. 12, “user 1” is associated as the user ID with the NFC card. The suspended jobs are successively number, starting with number 1. A “job ID” is assigned to each suspended job, and is transmitted by the image processing apparatus 10. An “address” is an address of the image processing apparatus 10 storing the suspended job, and is transmitted from the image processing apparatus 10. FIG. 12 illustrates a listing of number=1, the job ID of the suspended job “job 1”, and “address 1” as the address of the image processing apparatus 10 storing the suspended job.

The table of FIG. 12 is intended to mean that the user (user ID=user ID 1) holds the NFC card over the image processing apparatus 10 having address 1, and that the image processing apparatus 10 suspends the print jobs (job IDs=1 and 2) assigned to the user 1 (user ID). Since the image processing apparatus 10 transmits to the NFC card the address thereof (address 1) and the job IDs (jobs 1 and 2) of the print jobs that are suspended, these pieces of information are stored on the job list.

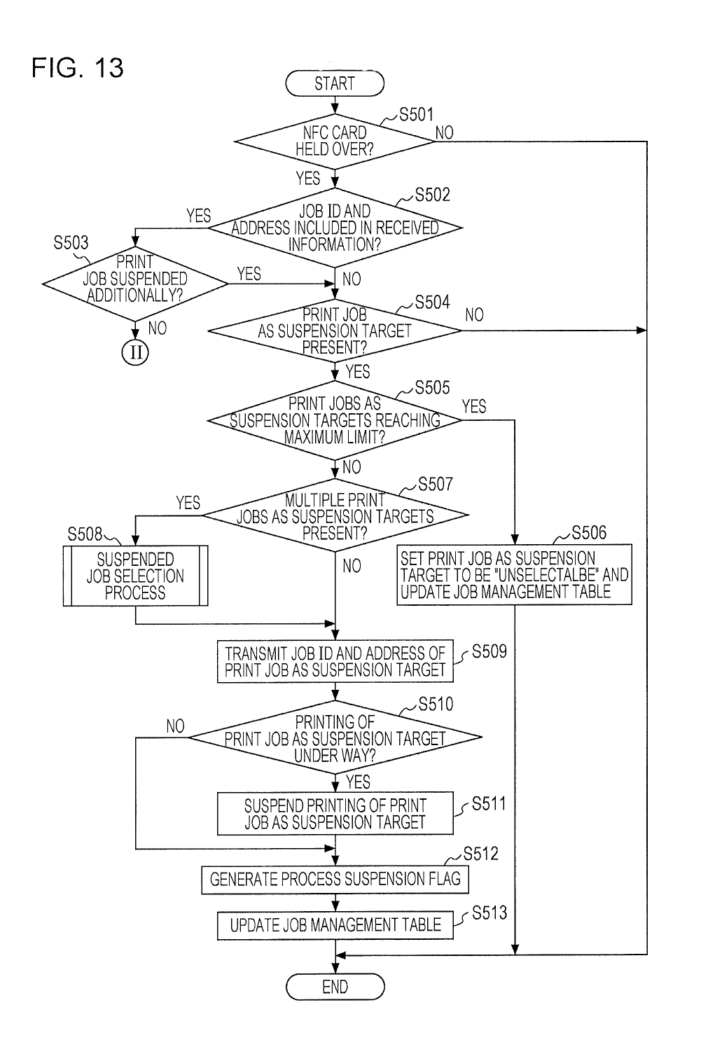

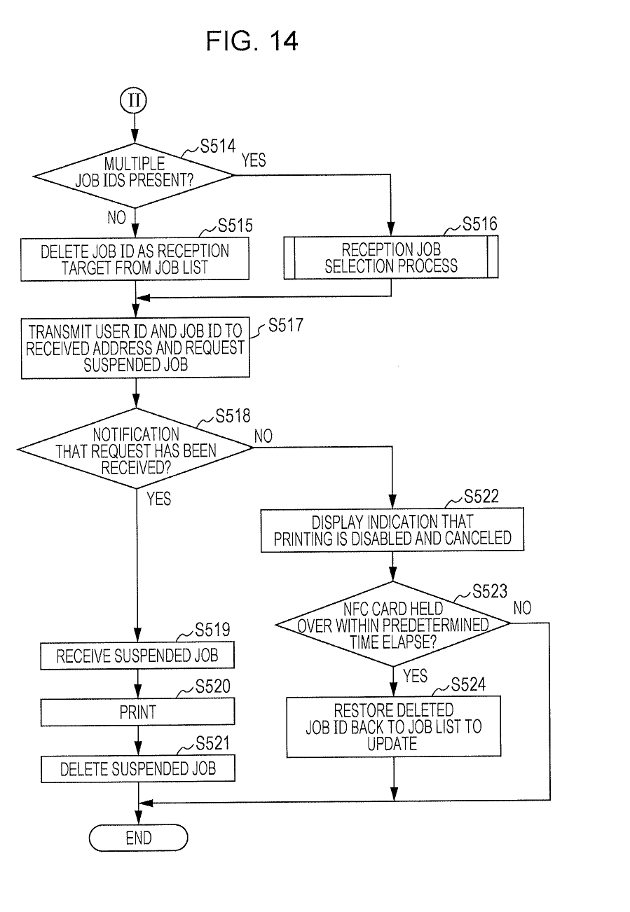

The image processing apparatus 10 performs the process described below when the NFC card is held over the image processing apparatus 10. FIG. 13 and FIG. 14 are flowcharts of the process performed by the image processing apparatus 10 when the NFC card is held over in the second exemplary embodiment.

The NFC controller 17 determines whether the NFC card is held over the NFC I/F 111 (step S501). If the NFC card is not held over the NFC I/F 111 (no branch from S501), processing ends. If the NFC card is held over the NFC I/F 111 (yes branch from S501), the NFC controller 17 performs the NFC communication to receive the information stored on the NFC card. The NFC controller 17 herein receives the user ID associated with the NFC card. If the suspended job is registered on the job list, the NFC controller 17 receives the information of the job ID of the registered suspended job and address.

The job management unit 18 determines whether the information received from the NFC card includes the job ID and address (step S502). If the information received from the NFC card includes the job ID and address (yes branch from S502), the job management unit 18 determines whether to additionally suspend the operation of a print job (step S503). For example, a message prompting the user to determine whether to additionally suspend the operation of the print job is displayed on the display 11. The determination is made based on the user's decision. If the user decides not to additionally suspend the operation of the print job (no branch from S503), the image processing apparatus 10 performs the print operation of the suspended job. Processing proceeds to step S514 as described below.

If the job management unit 18 determines that the operation of a print job is to be additionally suspended (yes branch from S503), or if it is determined in step S502 that at least one of the job ID and the address is not present (no branch from S502), the job management unit 18 determines whether there is a print job to be suspended (step S504). The job management unit 18 references the jog management table and determines that there is a print job as a suspension target if a print job having the same user ID as the user ID received from the NFC card is present among the print jobs that are under way or waiting for the print operation.

If there is no print job as a suspension target (no branch from S504), processing thus ends. If there is a print job as a suspension target (yes branch from S504), the job management unit 18 determines whether the number of print jobs having the user ID received from the NFC card in the “suspended” status has reached the upper limit (step S505). If the number of print jobs has reached the upper limit (yes branch from S505), the job management unit 18 sets the print job as the suspension target to be “unselectable” to update the jog management table (step S506). Processing thus ends.

If the number of print jobs has not reached the upper limit (no branch from step S505), the job management unit 18 determines whether multiple print jobs as suspension targets are present (step S507). If multiple jobs are present (yes branch from S507), a suspended job selection process is performed (step S508) to select on suspended job. Subsequent to the suspended job selection process, or if a single print job as a suspension target is present (no branch from S507), the job management unit 18 transmits to the NFC card the job ID of the print job as the suspension target and the address of the apparatus (step S509). If no print job is selected in the suspended job selection process, processing ends here. The suspended job selection process is described in detail below.

The job management unit 18 determines whether the print operation of the print job as the suspension target is under way (step S510). If the print operation is under way (yes branch from S510), the printer controller 14 suspends the print operation (step S511). If the print operation is not under way (no branch from S510), or subsequent to step S511, the job management unit 18 attaches the process suspension flag to the print job as the suspension target (step S512), and handles the print job as a suspended job. The job management unit 18 then sets the suspended job to be in the “suspended” status to update the jog management table (step S513). Proceeding thus ends.

If the job management unit 18 determines in step S503 that the operation of a print job is not to be additionally suspended (no branch from S503), the job management unit 18 determines whether multiple job IDs received from the NFC card are present (step S514). If the number of received job IDs is one (no branch from S514), the job management unit 18 sets the suspended job having that job ID to be a reception target. The job management unit 18 reads the job list of the NFC card and deletes the job ID as the reception target from the job list to update the job list (step S515). If the number of received job IDs is plural (yes branch from S514), a reception job selection process is performed to select a single job ID as a reception target (step S516). The reception job selection process is described in detail below.

The job management unit 18 transmits to the address received in step S501 the user ID received from the NFC card, and the job ID as the reception target, and requests the address to transmit the suspended job (step S517). The job management unit 18 determines whether a notification of the reception of a request within a predetermined time elapse is present (step S518). If a notification of the reception of a request within a predetermined time elapse is present (yes branch from S518), the job management unit 18 receives the transmitted suspended job (the suspended job having the job ID as the reception target) (step S519). The printer controller 14 performs the print operation responsive to the received suspended job (step S520). When the print operation is complete, the job management unit 18 deletes the suspended job (step S521).

On the other hand, if the notification of the reception of the request is not present (no branch from S518), the display 11 displays an indication of the disabled and canceled print operation (step S522). The NFC controller 17 determines whether the NFC card is held over the NFC I/F 111 within a predetermined time elapse (step S523). If the NFC card is held over the NFC I/F 111 within the predetermined time elapse (yes branch from step S523), the job management unit 18 restores the job ID deleted in step S515 or step S516 back into the job list to update the job list (step S524). If the NFC card is not held over the NFC I/F 111 within the predetermined time elapse (no branch from step S523), the job management unit 18 leaves the job list deleted from the job list. Processing then ends.

The image processing apparatus 10 repeats operations in steps S501 through S513 to suspend the operations of multiple print jobs. The image processing apparatus 10 repeats steps S501 through S503, and steps S514 through S524 to resume the operations of multiple print jobs. If, after the reception job selection process in step S516, step S517 and subsequent steps are performed in parallel with step S501 and subsequent steps, the selection of the suspended job as the reception target is performed in parallel with the operation to receive the suspended job.

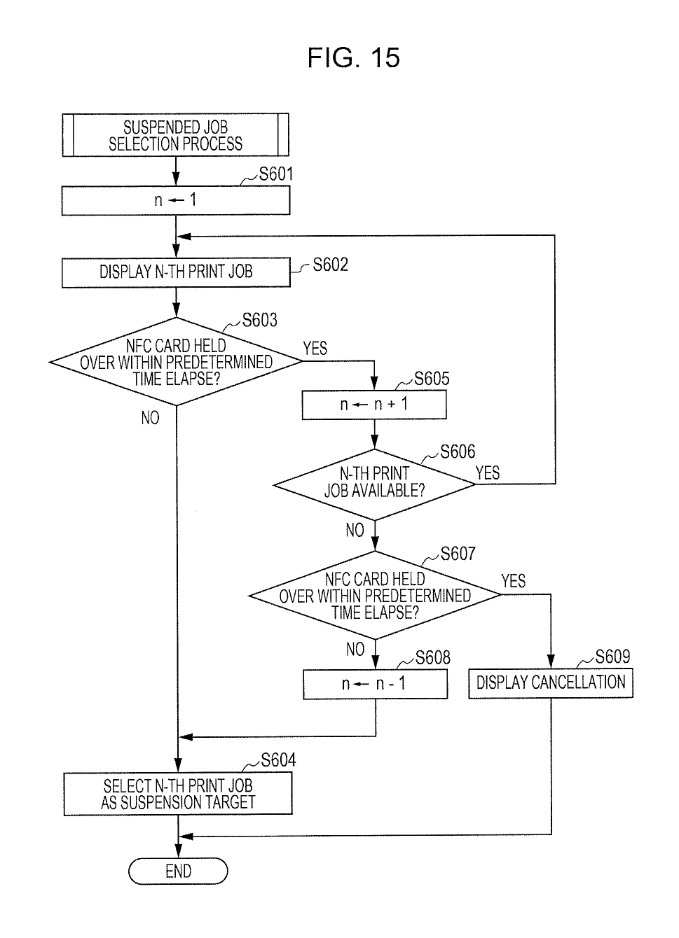

The suspended job selection process in step S508 of FIG. 13 is described. FIG. 15 is a flowchart illustrating an example of the suspended job selection process. In the same way as in FIG. 11, the print jobs are arranged in sequence in the jog management table.

The panel controller 13 sets n to be n=1 (step S601), and displays on the display 11 information of an n-th print job from among multiple print jobs as suspension targets (step S602). The NFC controller 17 determines whether the NFC card is held over within a predetermined time elapse (step S603). If the NFC card is not held over within a predetermined time elapse (no branch from S603), the job management unit 18 selects the n-th print job as a suspension target print job (step S604). Processing thus ends.

If the NFC card is held over within the predetermined time elapse (yes branch from S603), the job management unit 18 increments n by 1 (step S605) and determines whether an n-th print job as a suspension target is present (step S606). If an n-th print job is available (yes branch from S606), processing returns to step S602. If the number of print jobs as suspension targets is smaller than n, and the n-th print job is not present (no branch from S606), an indication that there is no n-th print job is displayed on the display 11. The NFC controller 17 determines whether the NFC card is held over within a predetermined time elapse (step S607).

If the NFC card is not held over within a predetermined time elapse (no branch from S607), the job management unit 18 decrements n by 1 (step S608), and proceeds to step S604. On the other hand, if the NFC card is held over within the predetermined time elapse (yes branch from S607), the panel controller 13 displays on the display 11 an indication that the suspension of the print job is to be canceled (step S609). Processing thus ends.

In the suspended job selection process, one print job is selected as a suspension target from the multiple print jobs depending on the number of user actions of holding the NFC card or the timing when the user holds the NFC card. Alternatively, the selection may be performed depending on a duration of time while the user holds the NFC card over.

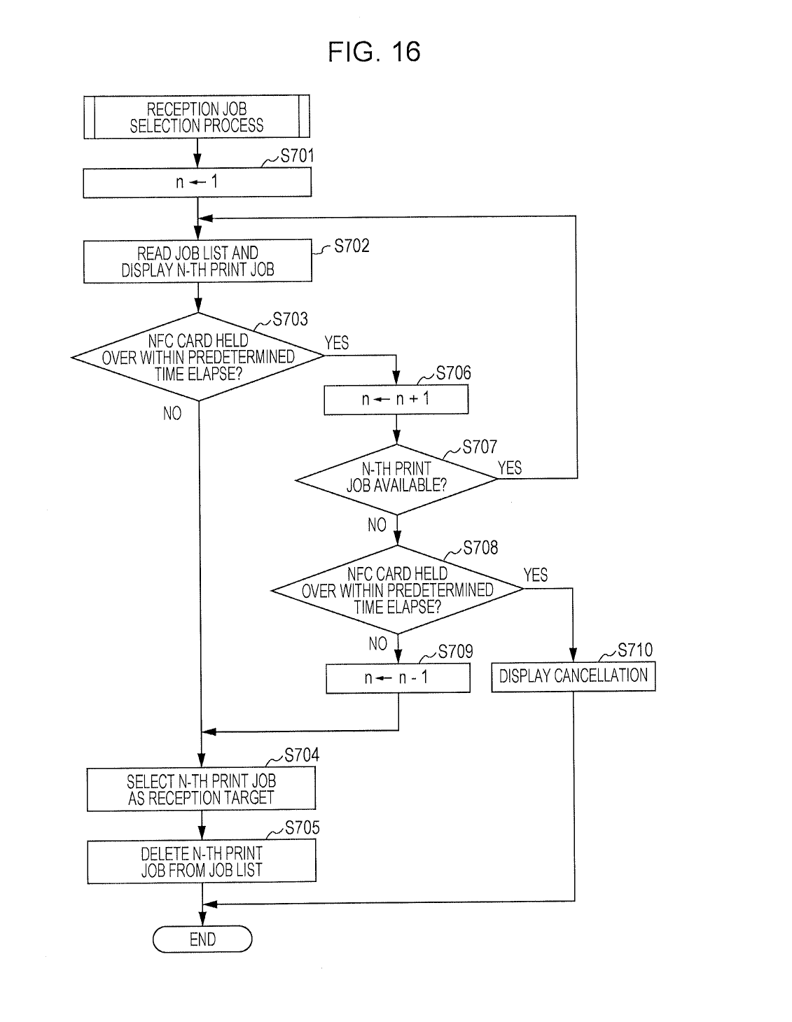

The reception job selection process in step S516 of FIG. 14 is described below. FIG. 16 is a flowchart illustrating an example of the reception job selection process. Referring to FIG. 12, the information of the suspended jobs is arranged in sequence on the job list.

The panel controller 13 sets n to be n=1 (step S701), reads the job list of the NFC card via the NFC controller 17, and displays the information of the n-th suspended job in the job list on the display 11 (step S702). The NFC controller 17 determines whether the NFC card is held over within a predetermined time elapse (step S703). If the NFC card is not held over within the predetermined time elapse (no branch from S703), the job management unit 18 selects an n-th suspended job as a reception target suspended job (step S704). The job management unit 18 deletes from the job list of the NFC card the information of the suspended job selected as the reception target (step S705). Processing thus end.

If the NFC card is held over (yes branch from S703), the job management unit 18 increments n by 1 (step S706), and determines whether an n-th suspended job is present (step S707). If the n-th suspended job is present (yes branch from S707), processing returns to step S702. If the number of suspended jobs is smaller than n, and the n-th suspended job is not present (no branch from S707), an indication that the n-th suspended job is not present is displayed on the display 11. The NFC controller 17 determines whether the NFC card is held over within a predetermined time elapse (step S708).

If the NFC card is not held over within the predetermined time elapse (no branch from S708), the job management unit 18 decrements n by 1 (step S709), and proceeds to step S704. If the NFC card is held over with the predetermined time elapse (yes branch from S708), the panel controller 13 displays on the display 11 an indication that the reception of the suspended job is to be canceled (step S710). Processing thus ends with no suspended job selected.

In the reception job selection process, one print job is selected as a reception target from the multiple print jobs depending on the number of user actions of holding the NFC card or the timing when the user holds the NFC card. The selection may be performed depending on a duration of time while the user holds the NFC card over.

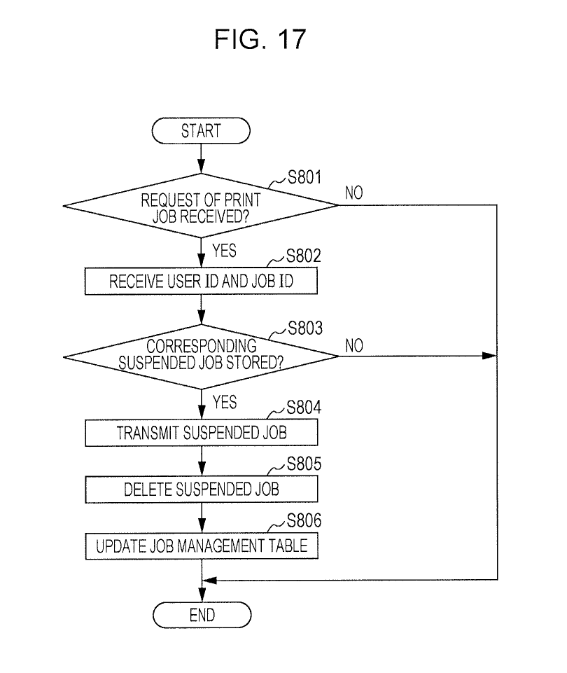

Described below is the transmission process in which one image processing apparatus 10 transmits a print job to another image processing apparatus 10. FIG. 17 is a flowchart illustrating an example of the transmission process of the print job performed by the image processing apparatus 10 of the second exemplary embodiment.

The job management unit 18 determines whether a request for a print job has been received from another image processing apparatus 10 (step S801). The job management unit 18 herein determines whether the request for the print job made in step S517 of FIG. 14 has been received. If the request has not been received (no branch from S801), processing ends. If the request has been received (yes branch from S801), the job management unit 18 receives the user ID and job ID from another image processing apparatus 10 (step S802), and determines whether the suspended job corresponding to the received user ID and job ID is stored on the job memory 19 (step S803). The job management unit 18 references the jog management table to determine whether the print job corresponding to the received user ID and job ID and in the “suspended” status is present.

If no such corresponding suspended job is not stored (no branch from S803), processing ends. If such a corresponding suspended job is stored (yes branch from S803), the job management unit 18 transmits to the image processing apparatus 10 as a request source in step S801 the notification that the request for the print job has been received. The job management unit 18 transmits the corresponding suspended job to the requesting image processing apparatus 10 (step S804). The job management unit 18 deletes the suspended job from the job memory 19 (step S805). The job management unit 18 deletes the suspended job from the jog management table, and updates the jog management table by setting the print job having the same user ID from the “unselectable” status to the “suspended” status in a manner such that the upper limit is not exceeded (step S806). Processing thus ends.

As described above, in the second exemplary embodiment, the print operation is suspended and resumed using the mobile terminal 20 or the NFC card having no memory capacity enough to store the print job. The user selects the operation to select the print job that is to be suspended or the operation to select the print job that is to be resumed by holding the NFC card over the image processing apparatus 10. In the same way as in the first exemplary embodiment, the workload on the user who uses the image processing apparatus 10 is reduced.

In the second exemplary embodiment, the print job in the “unselectable” status is suspended but is not a target to be transmitted to another image processing apparatus 10. The operation to be performed on the print job in the “unselectable” status may be determined by the user. For example, the operation of a print job that is in the “unselectable” status because of the upper limit may be left to the user's decision as to whether the print job is to be suspended or to be set in the “waiting” status without being set to be suspended.

The upper limit is set on the number of print jobs that are set to be in the “suspended” status. The present invention is not limited to this arrangement. For example, a print job that is not registered on the job list because of an insufficient memory space available on the NFC card may be set in the “unselectable” status.

In the second exemplary embodiment, the NFC card is used. The information to be indicated to the user, such as the message in step S503 of FIG. 13, is displayed on the display 11 in the image processing apparatus 10. If the mobile terminal 20 is used, the information to be indicated to the user may be displayed on the display 21 in the mobile terminal 20 such that the user enters an operation input. In the second exemplary embodiment, as in the first exemplary embodiment, the user may operate the operation panel 105 in the image processing apparatus 10 or the image display unit 205 in the mobile terminal 20 to select the print job to be suspended or the print job to be resumed.

In the first exemplary embodiment, as in the second exemplary embodiment, the print job whose operation is to be suspended may be selected or the print job to be transmitted from the mobile terminal 20 to the image processing apparatus 10 may be selected, depending on the number of user actions of holding the mobile terminal 20 over the image processing apparatus 10, the timing when the user holds the mobile terminal 20 over the image processing apparatus 10, or a duration of time while the user holds the mobile terminal 20 over the image processing apparatus 10.

In the first and second exemplary embodiments, the image processing apparatus 10 compares the user ID associated with the mobile terminal 20 with the user ID attached to the print job to determine whether a print job as a suspension target is present. The present invention is not limited to this arrangement. For example, when the mobile terminal 20 is held over, the image processing apparatus 10 sets the print job that is in the middle of the print operation at that moment to be a suspension target without paying attention to the user ID. In such a case, the image processing apparatus 10 determines in step S203 of FIG. 7 or in step S504 of FIG. 13 whether the print operation is under way. If the print operation is under way, the image processing apparatus 10 determines that the print job as the suspension target is present, and performs the subsequent steps.

In the first and second exemplary embodiments, the user performs the print operation using the operation terminal 30. Alternatively, the user may perform the print operation using the mobile terminal 20. In such a case, the mobile terminal 20 generates a print job in response to a user operation, and transmits the generated print job to the image processing apparatus 10. If the print job is received from the operation terminal 30 as described above, the image processing apparatus 10 identifies from the information of the operation terminal 30 a user who has performed the print operation, and then attaches the user ID to the print job. On the other hand, if the print job is received from the mobile terminal 20, the image processing apparatus 10 simply attaches the user ID to the print job because the user ID is associated with the mobile terminal 20.

In the first and second exemplary embodiments, the network 50 is a wired LAN. Alternatively, the network 50 may be a wireless LAN and data exchange between the image processing apparatuses 10 and data exchange between the image processing apparatus 10 and the operation terminal 30 may be performed using wireless communications.

In the first and second exemplary embodiments, wireless communications are performed between the image processing apparatus 10 and the mobile terminal 20 using the Wi-Fi Direct connection. The present invention is not limited to this arrangement. For example, wireless communications may be performed via a separately arranged access point (not illustrated). In such a case, wireless communications are performed between the image processing apparatus 10 and the access point and between the mobile terminal 20 and the access point. When the user holds the mobile terminal 20 over the image processing apparatus 10, IP addresses are exchanged therebetween. Wireless communications are thus performed between the image processing apparatus 10 and the mobile terminal 20 via the access point.

If the information received from the image processing apparatus 10 via the NFC communication includes SSID, the mobile terminal 20 establishes the Wi-Fi Direct connection. If the information does not include SSID, the mobile terminal 20 communicates via the access point. In this way, the mobile terminal 20 decides the connection procedure in view of the information received from the image processing apparatus 10.

The exemplary embodiments have been discussed. The scope of the present invention is not limited to the exemplary embodiments. It will be obvious to those skilled in the art that changes and modifications may be made without departing from the scope and spirit of the present invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus, comprising:
a first communication unit that wireless-communicates with a terminal apparatus;
a second communication unit that is different from the first communication unit and wireless-communicates with the terminal apparatus;
a transmitting unit that receives from the terminal apparatus via the second communication unit a suspend instruction to suspend an operation to perform a print instruction that instructs a document to be printed, suspends the operation to perform the print instruction, and transmits to the terminal apparatus via the first communication unit the print instruction with the operation thereof suspended; and
a receiving unit that receives from the terminal apparatus via the second communication unit a resume instruction to resume the operation to perform the print instruction, and receives the print instruction from the terminal apparatus via the first communication unit.

2. The image processing apparatus according to claim 1, wherein the receiving unit receives, from the terminal apparatus, as the resume instruction, information indicating that the terminal apparatus stores the print instruction.

3. An image processing apparatus, comprising:
a communication unit that wireless-communicates with a terminal apparatus; and
a receiving unit that receives, from the terminal apparatus via the communication unit, identification information identifying a print instruction to instruct a document to be printed, and recognition information recognizing an apparatus that stores the print instruction, and receives from another image processing apparatus the print instruction identified by the identification information if the apparatus recognized by the recognition information is the other image processing apparatus connected to the image processing apparatus via a communication line.

4. The image processing apparatus according to claim 3, further comprising an information transmitting unit that suspends the operation to perform the print instruction stored on the image processing apparatus if at least the identification information or the recognition information is not included in information received from the terminal apparatus via the communication unit, and transmits to the terminal apparatus via the communication unit the identification information of the print instruction with the operation thereof suspended, and the recognition information recognizing the image processing apparatus.

5. The image processing apparatus according to claim 4, further comprising a print instruction transmitting unit that, if the other image processing apparatus requests the print instruction identified by the identification information transmitted by the information transmitting unit, transmits the requested print instruction to the other image processing apparatus.

6. A terminal apparatus, comprising:
a wireless communication unit that wireless-communicates with an image processing apparatus;
an acquisition unit that provides to the image processing apparatus via the wireless communication unit a suspend instruction to suspend an operation to perform a print instruction that instructs a document to be printed, and acquires, from the image processing apparatus information, information of the print instruction with the operation thereof suspended; and
an instructing unit that, if the acquisition unit has acquired the information of the print instruction in wireless communications between the image processing apparatus and the wireless communication unit, provides to the image processing apparatus via the wireless communication unit a resume instruction to resume an operation corresponding to the acquired information of the print instruction.

7. The terminal apparatus according to claim 6, further comprising a receiving unit that, if the acquisition unit has acquired the information of the print instruction in wireless communications between the image processing apparatus and the wireless communication unit, receives an operation of a user as to which to select between providing the suspend instruction to the image processing apparatus and providing the resume instruction to the image processing apparatus.

8. The terminal apparatus according to claim 6, further comprising a memory that stores image data serving as a print target,
wherein the information of the print instruction acquired by the acquisition unit includes the image data.

9. The terminal apparatus according to claim 7, further comprising a memory that stores image data serving as a print target,
wherein the information of the print instruction acquired by the acquisition unit includes the image data.

10. An image processing system, comprising:
an image processing apparatus that prints a document; and
a terminal apparatus that stores a print instruction to instruct the document to be printed,
wherein the image processing apparatus includes
a first communication unit that wireless-communicates with the terminal apparatus,
a second communication unit that is different from the first communication unit and wireless-communicates with the terminal apparatus,
a transmitting unit that receives from the terminal apparatus via the second communication unit a suspend instruction to suspend an operation to perform a print instruction that instructs the document to be printed, suspends the operation to perform the print instruction, and transmits to the terminal apparatus via the first communication unit the print instruction with the operation thereof suspended,
a receiving unit that receives from the terminal apparatus via the second communication unit a resume instruction to resume the operation to perform the print instruction, and receives the print instruction from the terminal apparatus via the first communication unit, and
a printing unit that prints a document specified by the print instruction received by the receiving unit.

11. An image processing method comprising:
wireless-communicating with a terminal apparatus;
wireless-communicating with the terminal apparatus;
receiving from the terminal apparatus a suspend instruction to suspend an operation to perform a print instruction that instructs a document to be printed, suspending the operation to perform the print instruction, and transmitting to the terminal apparatus the print instruction with the operation thereof suspended; and
receiving from the terminal apparatus a resume instruction to resume the operation to perform the print instruction, and receiving the print instruction from the terminal apparatus.

12. A non-transitory computer readable medium storing a program causing a computer to execute a process for processing an image, the process comprising:
wireless-communicating with a terminal apparatus;
wireless-communicating with the terminal apparatus;
receiving from the terminal apparatus a suspend instruction to suspend an operation to perform a print instruction that instructs a document to be printed, suspending the operation to perform the print instruction, and transmitting to the terminal apparatus the print instruction with the operation thereof suspended; and
receiving from the terminal apparatus a resume instruction to resume the operation to perform the print instruction, and receiving the print instruction from the terminal apparatus.
